(19) United States
(12) Patent Application Publication
(10) Pub. No.: US 2009/0233162 A1
(43) Pub. Date: Sep. 17, 2009

(54) BATTERY ASSEMBLY COMPONENT

(76) Inventors: Yo-Fu FANG, Taipei City (TW); Tung Lung Chou, Taipei City (TW); Chun-Chu Lin, Taipei City (TW)

Correspondence Address: SINORICA, LLC, 2275 Research Blvd., Suite 500, ROCKVILLE, MD, 20850, US

(21) Appl. No.: 12/111,198

(22) Filed: Apr. 29, 2008

(30) Foreign Application Priority Data
Mar. 11, 2008 (TW) 97204115

(51) Int. Cl. H01M 2/10

(52) U.S. Cl. 429/99

(57) ABSTRACT

The present invention discloses a battery assembly component, which comprises a sleeve set having a first sleeve element and a second sleeve element. The two sleeve elements respectively have accommodation spaces. The two sleeve elements are joined at a point on neighboring edges of the two sleeve elements. The inner rim of the first sleeve element and the outer rim of the second sleeve element are on the same plane, and the accommodation spaces of the two sleeve elements are parallel. In assembling, the second sleeve element of one sleeve set is arranged to coincide with the first sleeve element of another sleeve set. Next, a battery cell is placed into the interconnecting accommodation spaces. The assemblage of the battery assembly components can be infinitely expanded via repeating the abovementioned steps. Therefore, the present invention can assemble battery cells to obtain different battery modules providing different voltages and power outputs.

### BACKGROUND OF THE INVENTION

1. Field of the Invention

The present invention relates to a battery assembly component, particularly to a battery assembly component, which can flexibly cascades or parallels different numbers of battery cells, whereby battery cells can be conveniently configured and easily assembled to satisfy various applications.

2. Description of the Related Art

Lithium batteries have been proved to have superior electric performance and have been widely used in portable consumer electronics, such as mobile phones, PDA (Personal Digital Assistant), handheld tools, notebook computers, etc. The battery module of assembled lithium battery cells also has been improved in safety to such an extent that it can satisfy general requirements of electric vehicles. Generally, mobile phones, notebook computers, or handheld tools, adopt a simpler power supply module-usually a combination of four or six battery cells. However, electric vehicles, such as electric bikes, electric motorcycles, golf carts, hybrid cars, etc., use various power supply modules of different rated voltages and power outputs. Therefore, a single power supply module is unlikely to satisfy requirements of various electric vehicles.

A battery module of assembled lithium battery cells needs assembly brackets or casings, which increases the cost of molds. Besides, the battery module should be able to overcome impact or vibration, which may cause the collision or drop of cells. Further, the battery module should be able to overcome the electrical/thermal insulation of cells.

How to economically assemble battery modules with different numbers of lithium battery cells to satisfy various requirements has been an important topic for the manufactures desirous to expand the market of lithium batteries.

### SUMMARY OF THE INVENTION

One objective of the present invention is to provide a battery assembly component, which can simplify and convenience battery assembly, reduce assembly manpower, and promote assembly efficiency, and which can also decrease the number of molds, lower the fabrication cost and increase the economic benefits.

Another objective of the present invention is to provide a battery assembly component, which achieves an unlimited expandability via flexibly assembling identical-structure sleeve sets to accommodate different numbers of battery cells.

Further objective of the present invention is to provide a battery assembly component, which prevents battery cells from collision and drop and thermally insulates battery cells, whereby the security and reliability of a battery module is enhanced.

To achieve the abovementioned objectives, the present invention proposes a battery assembly component, which comprises a sleeve set having a first sleeve element and a second sleeve element. The two sleeve elements respectively have accommodation spaces accommodating battery cells. The two sleeve elements are joined at a point on neighboring edges of the two sleeve elements. The inner rim of the first sleeve element and the outer rim of the second sleeve element are on the same plane, and the accommodation spaces of the two sleeve elements are parallel. In assembling the battery assembly components, the second sleeve element of one sleeve set is arranged to coincide with the first sleeve element of another sleeve set so that the accommodation space of the second sleeve element of the former sleeve set interconnects with the accommodation space of the first sleeve element of the latter sleeve set. Next, a battery cell is placed into the interconnecting accommodation spaces. Next, other sleeve sets and battery cells are added into the assemblage in the same way until the assemblage has a desired quantity of battery cells. Thereby, the present invention can assemble battery cells securely to obtain different battery modules providing different voltages and power outputs.

Below, the embodiments of the present invention are described in detail in cooperation with the drawings to make easily understood the objectives, technical characteristics and accomplishments of the present invention.

### BRIEF DESCRIPTION OF THE DRAWINGS

FIG. 1 is a perspective view schematically showing a battery assembly component according to the present invention;

FIG. 2 is an exploded view schematically showing a packing process according to the present invention;

FIG. 3 is an exploded view schematically showing an assembling process of battery assembly components according to a first embodiment of the present invention;

FIG. 4 is a perspective view schematically showing an assembling process of battery assembly components according to the first embodiment of the present invention;

FIG. 5 is a perspective view schematically showing an assemblage of battery assembly components according to the first embodiment of the present invention;

FIG. 6 is an exploded view schematically showing an assembling process of battery assembly components according to a second embodiment of the present invention;

FIG. 7 is a perspective view schematically showing an assembling process of battery assembly components according to the second embodiment of the present invention;

FIG. 8 is another exploded view schematically showing an assembling process of battery assembly components according to the second embodiment of the present invention;

FIG. 9 is another perspective view schematically showing an assembling process of battery assembly components according to the second embodiment of the present invention;

FIG. 10 is a perspective view schematically showing an assemblage of battery assembly components according to the second embodiment of the present invention;

FIG. 11 is an exploded view schematically showing a packaging process of battery assembly components according to the present invention;

and

FIG. 12 is a perspective view schematically showing a package of battery assembly components according to the present invention.

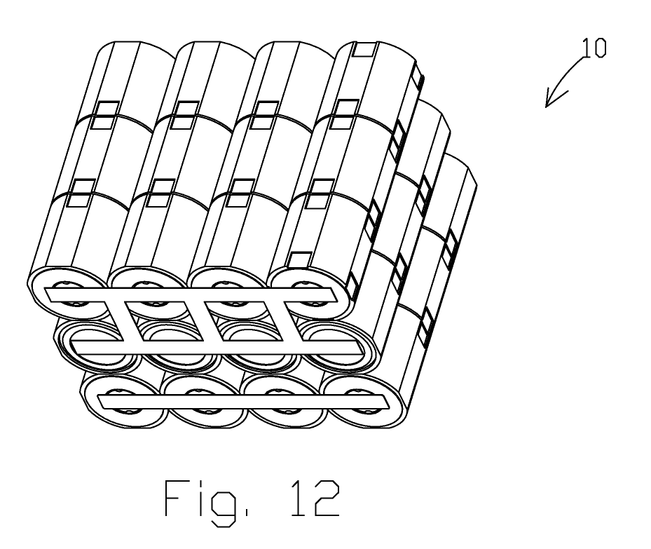

### DETAILED DESCRIPTION OF THE INVENTION

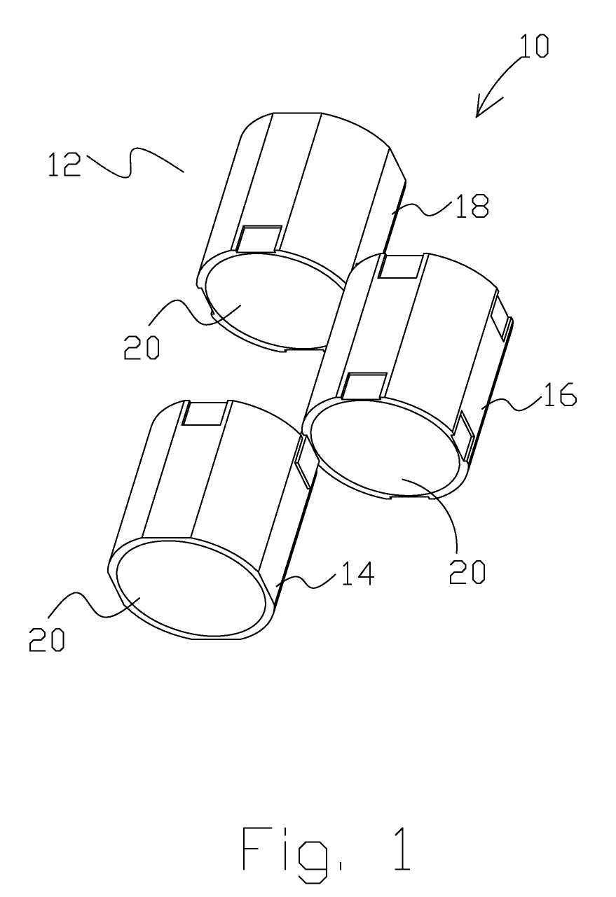

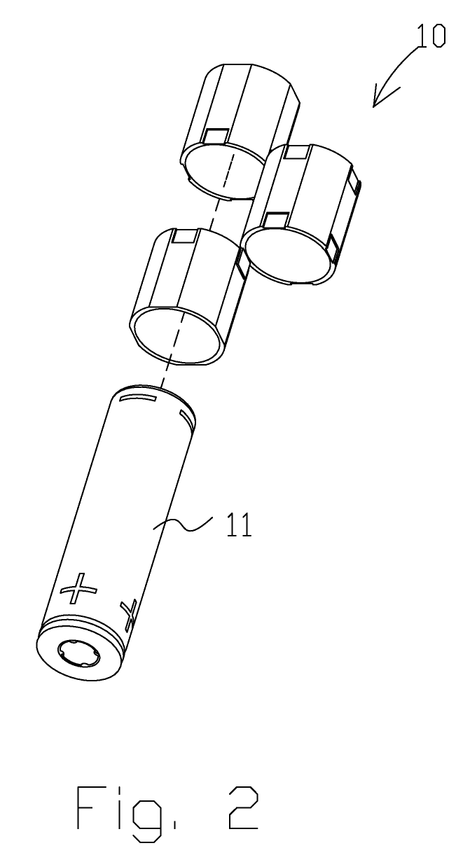

Refer to FIG. 1 and FIG. 2 for a battery assembly component according to the present invention, wherein a battery assembly component for a standard cylindrical battery cell, such as a 18650 Li-polymer cell, is used to exemplify the present invention. The battery assembly component 10 of the present invention comprises: a sleeve set 12 having a first sleeve element 14, a second sleeve element 16 and a third sleeve element 18, which are made of an insulating material, such as ABS (Acrylonitrile Butadiene Styrene), PVC (Polyvinylchloride), ABS+PVC, or nylon. The first sleeve element 14, second sleeve element 16 and third sleeve element 18 respectively have accommodation spaces 20 used to accommodate cylindrical battery cells. The three sleeve elements are joined at the edges thereof, wherein the outer rim of the second sleeve element 16 and the inner rims of the first sleeve element 14 and third sleeve element 18 are on the same plane, and wherein the accommodation space 20 of the second sleeve element 16 is parallel to the accommodation spaces 20 of the first sleeve element 14 and third sleeve element 18. The sleeve elements may have a polygonal cross section, whereby the sleeve elements can contact each other closely. The three sleeve elements of the sleeve set 12 can be fabricated into a one-piece part via an injection molding process. The packing of one battery assembly component 10 is realized via inserting a battery cell 11 into the accommodation spaces 20 of the first and third sleeve elements 14 and 18.

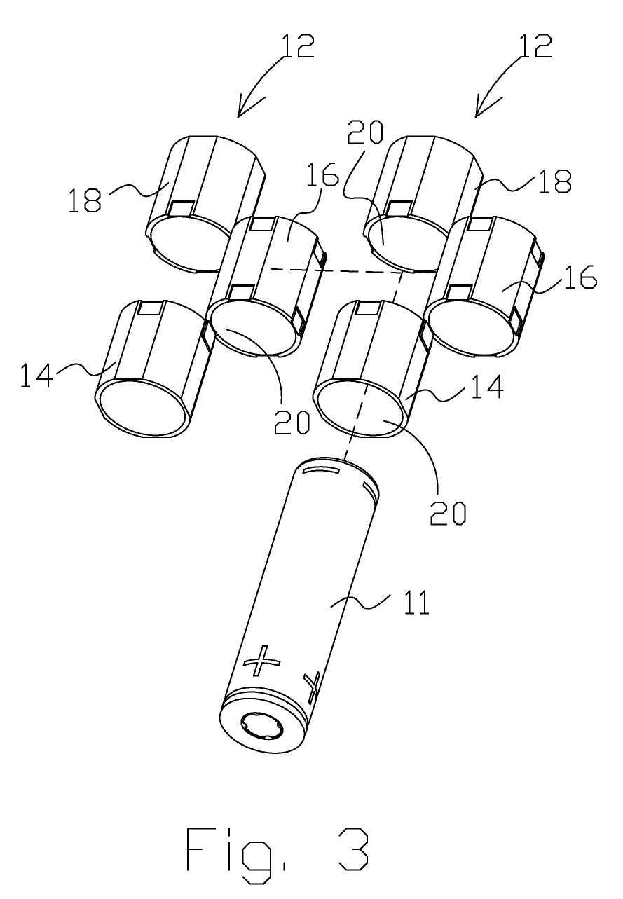

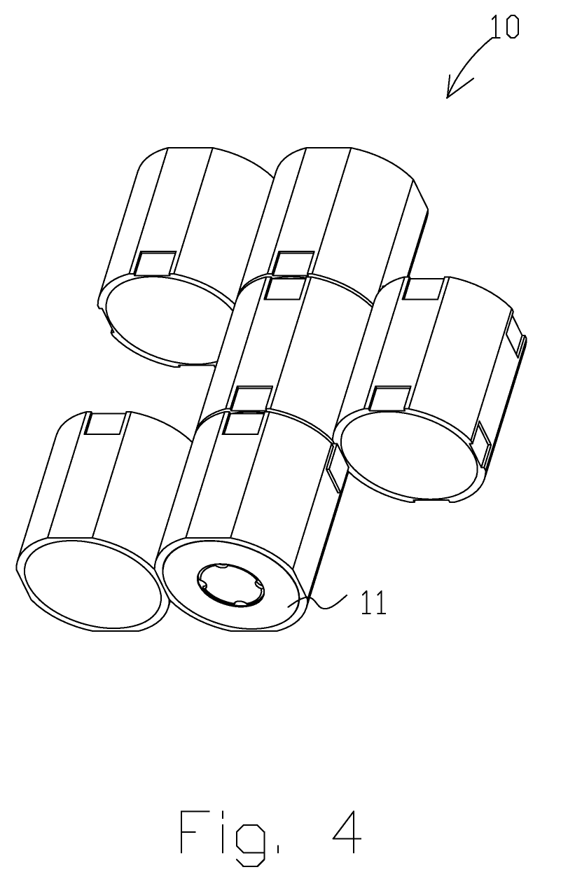

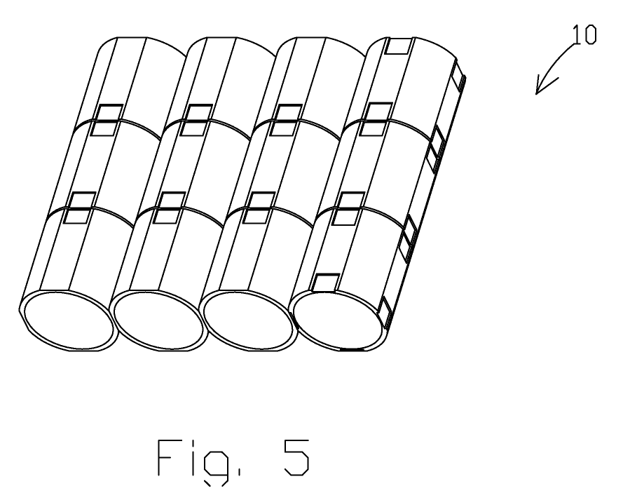

Refer to FIG. 3 and FIG. 4 for a two-dimensional assemblage of the battery assembly components 10 according a first embodiment of the present invention. Firstly, the second sleeve element 16 of one sleeve set 12 is pushed into between the first and second sleeve elements 14 and 18 of another sleeve set 12 to make the surface of the second sleeve element 16 of the former sleeve set 12 contact the surface of the second sleeve element 16 of the latter sleeve set 12, so that the inner rim of the accommodation space 20 of the second sleeve element 16 of the former sleeve set 12 completely coincides with the inner rims of the accommodation spaces 20 of the first and third sleeve elements of the latter sleeve set 12. Thus, the accommodation space 20 of the second sleeve element 16 of the former sleeve set 12 completely interconnects the accommodation spaces 20 of the first and third sleeve elements of the latter sleeve set 12. Next, a battery cell 11 is placed into the interconnecting accommodation spaces 20 of the former and latter sleeve sets 12. Thus is completed the assemblage of the battery assembly components 10. The three sleeve elements can enhance the electrical insulation and thermal insulation of battery cells 11. Refer to FIG. 5. Similarly, more sleeve sets 12 may be sequentially assembled together until the assemblage has a given quantity of sleeve sets 12.

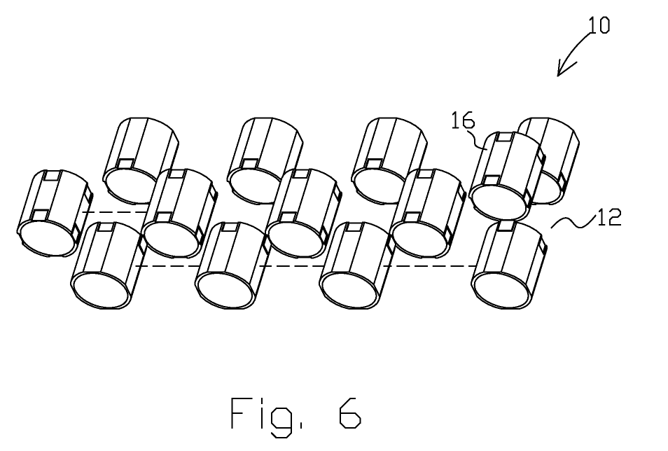

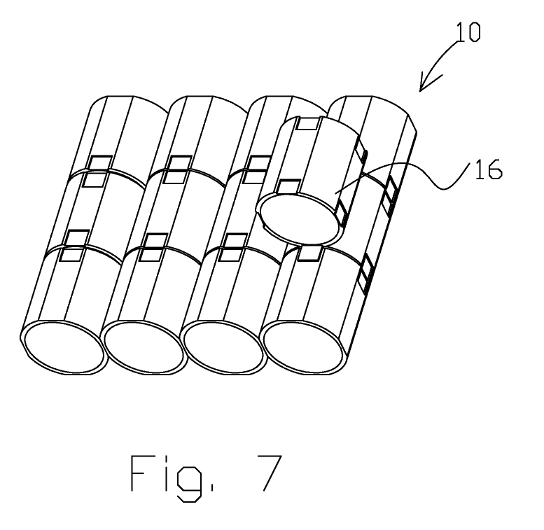

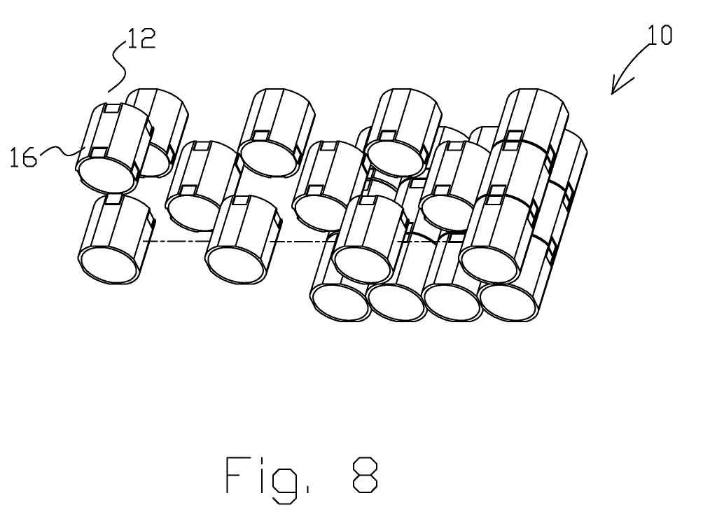

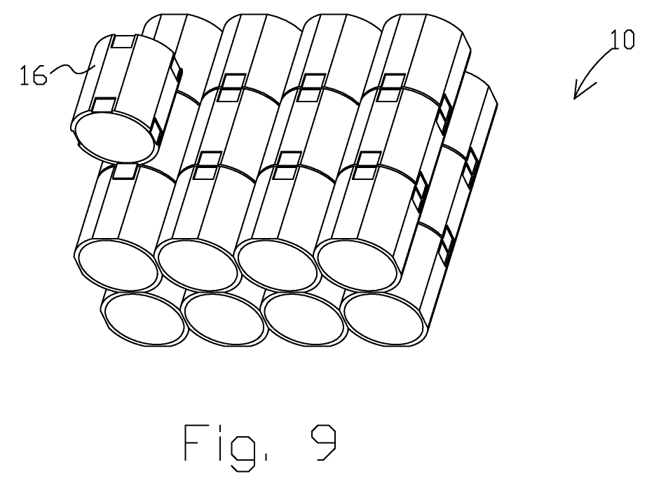

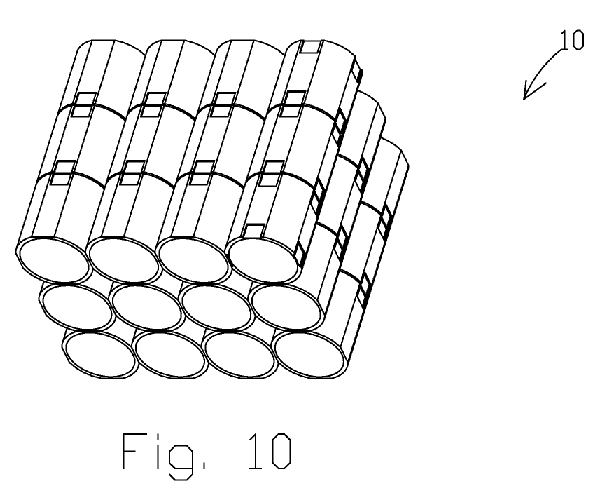

Refer to FIG. 6 for a three-dimensional assemblage of the battery assembly components 10 according a second embodiment of the present invention. The first embodiment is a two-dimensional assemblage of the battery assembly components 10, but the second embodiment is a three-dimensional assemblage of the battery assembly components 10. In the second embodiment, the second sleeve element 16 of one sleeve set 12 is faced upward firstly. Similarly to the first embodiment, more sleeve sets 12 are moved horizontally from left to right and sequentially assembled together to form the first row of battery assembly components 10 having a given quantity of sleeve sets 12. Refer to FIG. 7. Next, with the upward-faced second sleeve element 16 of the rightmost sleeve set 12 being the beginning, more sleeve sets 12 are moved horizontally from left to right and sequentially assembled together to form the second row of battery assembly components 10 having the given quantity of sleeve sets 12, wherein the second sleeve element 16 of the last (leftmost) sleeve set 12 is faced upward, as shown in FIG. 8. Refer to FIG. 9. Next, with the upward-faced second sleeve element 16 of the leftmost sleeve set 12 being the beginning, more sleeve sets 12 are moved horizontally from right to left and sequentially assembled together to form the third row of battery assembly components 10 having the given quantity of sleeve sets 12, as shown in FIG. 10. The fourth row of battery assembly components 10 can be obtained with the same steps if necessary. Thereby, the battery assembly components 10 of the present invention can flexibly assemble different numbers of battery cells 11 to achieve an unlimited expandability.

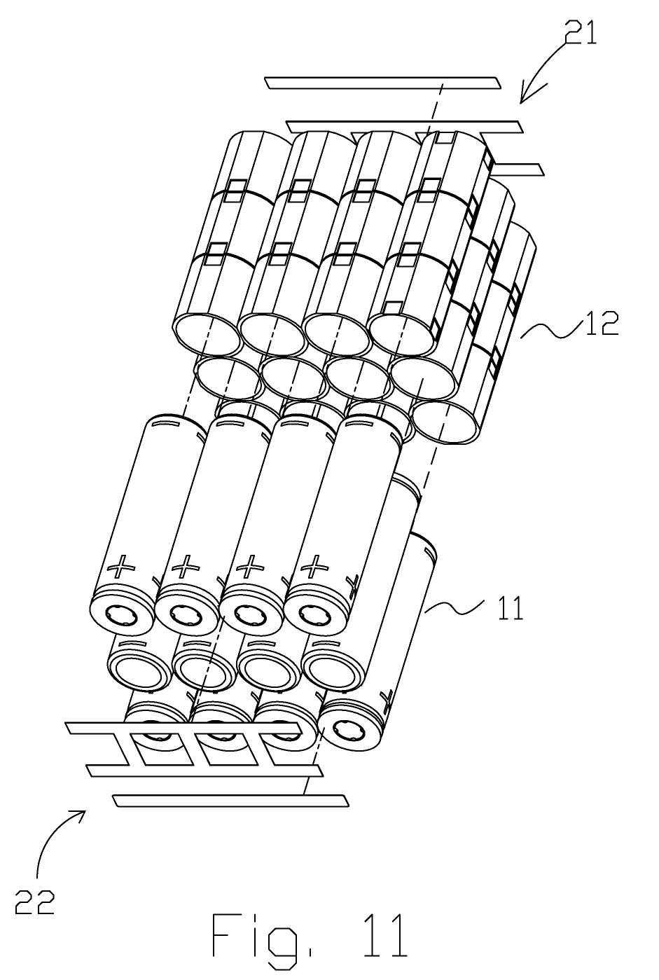

Refer to FIG. 11. After the assemblage of the battery assembly components 10 is completed, metallic conduction plates 21 and 22, such as nickel plates, are respectively installed on the top face and bottom face of the sleeve sets 12 to contact the positive and negative electrodes of the battery cells 11. The metallic conduction plates 21 and 22 may be fixed via spot welding. Thereby, the battery cells 11 are connected in series. Thus is completed a package of the battery assembly components 10, which can implement a power module providing required voltage and power output.

Via only a single type of sleeve sets, the present invention can achieve the configuration flexibility and assembly simplification of battery cells, improve the assembly efficiency, reduce the assembly cost, and promote the economic benefits.

From the above description, it is proved that the present can really simplify the assembly procedures of batteries, and that the present invention is indeed a superior innovation. Thus, the Inventor files the application for a patent.

Herein, it should be particularly pointed out that the preferred embodiments described above are only to exemplify the present invention but not to limit the scope of the present invention, and that any equivalent modification or variation according to the spirit of the present invention is to be also included within the scope of the present invention.

What is claimed is:

1. A battery assembly component, comprising:
a sleeve set, having a first sleeve element and a second sleeve element, wherein said two sleeve elements respectively have accommodation spaces accommodating battery cells, and said two sleeve elements are joined at a point on neighboring edges of said two sleeve elements.

2. The battery assembly component according to claim 1, wherein an inner rim of said first sleeve element and an outer rim of said second sleeve element are on a same plane.

3. The battery assembly component according to claim 1, wherein said accommodation spaces are parallel.

4. The battery assembly component according to claim 2, wherein an inner rim of said first sleeve element and said outer rim of said second sleeve element are polygons.

5. The battery assembly component according to claim 4, wherein said outer rims of said first and second sleeve elements are identical in shape and size.

6. The battery assembly component according to claim 1, wherein said sleeve set is fabricated into a one-piece part via an injection molding process.

7. The battery assembly component according to claim 1, wherein said sleeve set is made of an insulating material, and said insulating material is ABS (Acrylonitrile Butadiene Styrene), PVC (Polyvinylchloride), ABS+PVC, or nylon.

8. The battery assembly component according to claim 1, further comprising at least one assembly sleeve set, wherein said at least one assembly sleeve set has a structure identical to that of said sleeve set and is assembled to said sleeve set.

9. The battery assembly component according to claim 8, wherein said assembly sleeve set and said sleeve set are assembled together horizontally or vertically.
